(19) United States
(12) Patent Application Publication
(10) Pub. No.: US 2012/0099579 A1
(43) Pub. Date: Apr. 26, 2012

(54) ZIGBEE GATEWAY AND IP SERVICE SERVER INTERWORKING WITH ZIGBEE GATEWAY THROUGH IP NETWORK

(76) Inventors: Yeon-soo Kim, Gyeonggi-do (KR); Jae-Woo Park, Seoul (KR); Woo-Sik Lee, Seoul (KR); Suk-Ju Jung, Seoul (KR)

(21) Appl. No.: 13/382,064

(22) PCT Filed: Jun. 24, 2010
(86) PCT No.: PCT/KR2010/004108

§ 371 Date: Jan. 3, 2012

(30) Foreign Application Priority Data
Jul. 3, 2009 (KR) 10-2009-0060866

(51) Int. Cl. H04W 92/00; H04L 12/56

(52) U.S. Cl. 370/338

(57) ABSTRACT

A Zigbee gateway connected to a Zigbee node by a Zigbee network and connected to an IP service server through an IP network includes a primitive transport layer module and a Zigbee network layer module. The primitive transport layer module of the Zigbee gateway extracts first data from a first primitive frame packet transferred through the IP network from the IP service server. The Zigbee network layer module receives the first data from the primitive transport layer module and transfers the first data to a Zigbee node. The IP service server interworking with the Zigbee gateway through the IP network includes a primitive transport layer module and a Zigbee application layer module. The primitive transport layer module of the IP service server extracts first data from a first primitive frame packet transferred through the IP network from the Zigbee gateway. The Zigbee application layer module receives the first data from the primitive transport layer module.

### CROSS-REFERENCE TO RELATED APPLICATION

This application claims priority to and the benefit of Korean Patent Application No. 10-2009-0060866 filed in the Korean Intellectual Property Office on Jul. 3, 2009, the entire contents of which are incorporated herein by reference.

### BACKGROUND OF THE INVENTION

(a) Field of the Invention

The present invention relates to a Zigbee gateway and an IP service server interworking with the Zigbee gateway through an IP network.

(b) Description of the Related Art

A Zigbee network is a low power, low speed wireless network having short-distance connectivity capable of remotely monitoring and controlling an environment, an object, a space, or the like, through a sensor. The Zigbee technique, which is based on IEEE 802.15.4 standard defining a low power, low speed wireless interface for a small device having limited power, central processing unit (CPU), and memory resource, includes a network allowing for networking between Zigbee devices and an application protocol.

A Zigbee protocol stack is mounted on an IEEE 802.15.4 wireless communication standard. The Zigbee standard provides a network layer and an application layer to support a user application. The network layer provides a mechanism of participating in a network, leaving the network, and transmitting a message to an appropriate destination, manages formation of a Zigbee network, and assigns an address to a node participating the network. The application layer includes an application frame work, an application support sublayer, and a Zigbee device object. Such inter-layer communication is performed by a primitive in case of upper and lower layers and performed by a frame in case of equal layers.

In this manner, the Zigbee protocol allows two or more Zigbee nodes within the same Zigbee network to communicate. However, the Zigbee protocol does not provide a mechanism allowing a Zigbee node to communicate with an IP node in an IP network.

Thus, an interworking method using a gateway supporting effective communication between an IP node in an IP network and a Zigbee node is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a Zigbee gateway having advantages of transmitting and receiving a message between an IP network and a Zigbee network without having to convert a format, and an IP service server which cooperatively operates through the IP network.

An exemplary embodiment of the present invention provides a Zigbee gateway connected to a Zigbee node by a Zigbee network and connected to an IP service server through an IP network, including:

a primitive transport layer module extracting first data from a first primitive frame packet transferred through the IP network from the IP service server; and a Zigbee network layer module receiving the first data from the primitive transport layer module and transferring the first data to the Zigbee node.

Another embodiment of the present invention provides an IP service server interworking with a Zigbee gateway through an IP network, including:

a primitive transport layer module extracting first data from a first primitive frame packet transferred through the IP network from the Zigbee gateway; and a Zigbee application layer module receiving the first data from the primitive transport layer module.

### BRIEF DESCRIPTION OF THE DRAWINGS

FIG. 1 is a view schematically showing a system allowing for interworking between an IP network and a Zigbee network according to an embodiment of the present invention.

FIG. 2 is a view schematically showing a format of a primitive frame packet according to an embodiment of the present invention.

FIG. 3 is a view schematically showing transmission and reception of a primitive frame packet according to an embodiment of the present invention.

FIG. 4 is a view schematically showing a procedure of transferring a primitive message according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements. Also, throughout the specification, an IP network includes at least one of Internet protocol version 4 (IPv4) and a follow-up version IP network such as Internet protocol version 6 (IPv6).

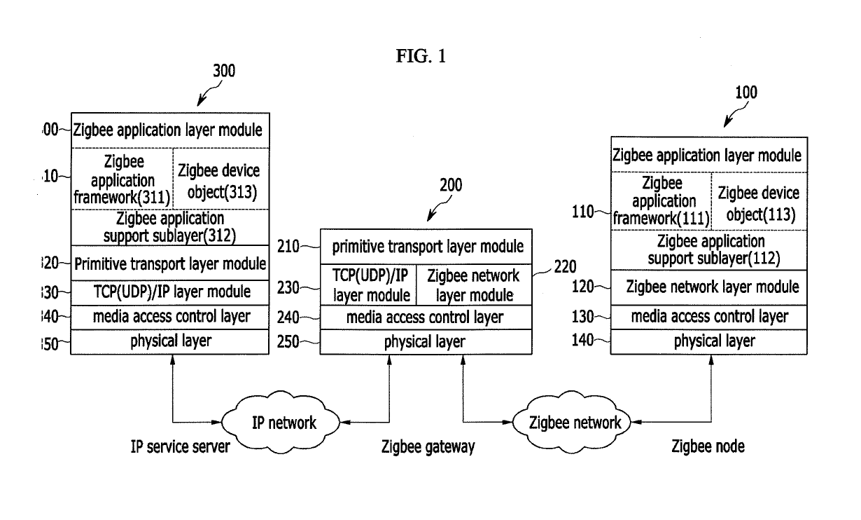

FIG. 1 is a view schematically showing a system allowing for interworking between an IP network and a Zigbee network according to an embodiment of the present invention.

As shown in FIG. 1, the system 1 allowing for interworking between an IP network and a Zigbee network according to an embodiment of the present invention includes a Zigbee node 100, a Zigbee gateway 200 located between an IP network and a Zigbee network, and an IP service server 300 located in the IP network.

The Zigbee node 100 includes a Zigbee application layer module 110 for an application service, a Zigbee network layer module 120, a media access control (MAC) layer 130, and a physical layer 140. The MAC layer 130 and the physical layer 140 may follow the IEEE 802.15.4 standard.

The Zigbee application layer module 110 includes a Zigbee application framework 111, a Zigbee application support sublayer 112, and a Zigbee device object 113. The Zigbee application framework 111 provides an interface between the Zigbee application support sublayer 112 and the Zigbee device object 113 and implements logical association between applications objects. The Zigbee application support sublayer 112 provides an appropriate application support when a message reaches the Zigbee node 100. The Zigbee device object 113 denotes a node type of a device, and initiates a device and service discovery in the Zigbee network.

The Zigbee network layer module 120 provides a mechanism for transmitting a message for participating in or leaving a network to an appropriate destination. The Zigbee network layer module 120 provides a mechanism for a device and service discovery. The Zigbee network layer module 120 manages formation of a Zigbee network and assigns an address to a node that participates in the network.

The Zigbee gateway 200 has interfaces of the IP network and the Zigbee network, and includes a primitive transport layer module 210, a Zigbee network layer module 220, a TCP(UDP)/IP layer module 230, a MAC layer 240, and a physical layer 250. The MAC layer 240 and the physical layer 250 may follow the IEEE 802.15.4 standard.

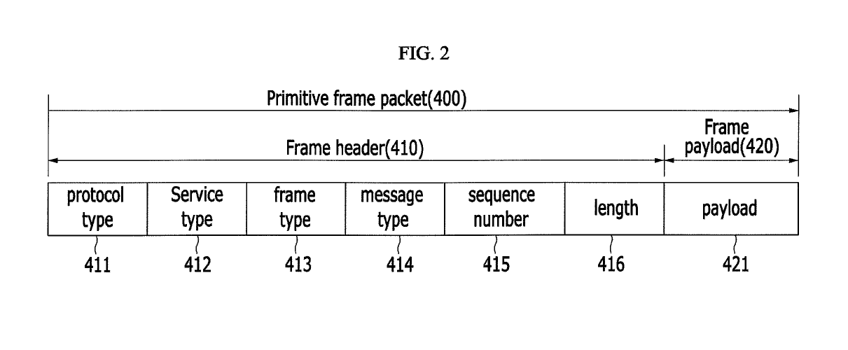

The primitive transport layer module 210 receives a primitive and a parameter from the Zigbee network layer module 220, and generates a primitive frame packet by using the received primitive and the parameter. The primitive frame packet according to an embodiment of the present invention will be described later with reference to FIG. 2. The primitive transport layer module 210 transfers the generated primitive frame packet to the IP service server 300 through the TCP(UDP)/IP layer module 230. Namely, the primitive transport layer module 210 transfers the primitive and the parameter, which are exchanged with the IP service server 300 away in the IP network, as a single primitive frame packet to the IP service server 300. Also, when a primitive frame packet, which has been generated according to a primitive and a parameter transferred from the IP service server 300, is transferred, the primitive transport layer module 210 analyzes the transferred primitive frame packet, restores the original primitive and parameter before being generated as the primitive frame packet, and transfers the restored original primitive and parameter to the Zigbee node 100.

The Zigbee network layer module 220 receives a primitive and a parameter from the Zigbee node 100 and transfers the received primitive and parameter to the primitive transport layer module 210. The Zigbee network layer module 220 provides a mechanism for transmitting a message for participating in or leaving a network to an appropriate destination. The Zigbee network layer module 220 provides a mechanism for a device and service discovery. The Zigbee network layer module 220 manages formation of a Zigbee network and assigns an address to a node that participates in the network.

The TCP(UDP)/IP layer module 230 transfers the primitive and parameter restored in the primitive transport layer module 210 to the Zigbee node 100 or transfers the primitive frame packet generated according to the primitive and parameter transferred from the Zigbee node 100 to the IP service server 300. The IP service server 300 includes a Zigbee application layer module 310, a primitive transport layer module 320, a TCP(UDP)/IP layer module 330, a MAC layer 340, and a physical layer 350. The MAC layer 340 and the physical layer 350 may follow the IEEE 802.15.4 protocol standard. The IP service server 300 operates as an IP service providing device.

The Zigbee application layer module 310 includes a Zigbee application framework 311, a Zigbee application support sublayer 312, and a Zigbee device object 313, and transfers a primitive and a parameter to be transferred to the Zigbee node 100 to the primitive transport layer module 320. Here, the functions of the Zigbee application framework 311, the Zigbee application support sublayer 312, and the Zigbee device object 313 are the same as those of the Zigbee application framework 111, the Zigbee application support sublayer 112, and the Zigbee device object 113, so a detailed description thereof will be omitted.

The primitive transport layer module 320 receives a primitive and a parameter from the Zigbee application layer module 310, and generates a primitive frame packet by using the transferred primitive and parameter. The primitive transport layer module 320 transfers the generated primitive frame packet to the Zigbee gateway 200 through the TCP(UDP)/IP layer module 330. Namely, the primitive transport layer module 320 transfers the primitive and the parameter, which are exchanged with the Zigbee gateway 200 away in the IP network, as a single primitive frame packet to the Zigbee gateway 200. Also, when a primitive frame packet, which has been generated according to a primitive and a parameter transferred from the Zigbee node 100, is transferred, the primitive transport layer module 320 analyzes the transferred primitive frame packet, restores the original primitive and parameter before being generated as the primitive frame packet, and transfers the restored original primitive and parameter to the Zigbee application layer module 310.

The TCP(UDP)/IP layer module 330 transfers the primitive frame packet transferred from the primitive transport layer module 320 to the Zigbee gateway 200 to the primitive frame packet transferred form the Zigbee gateway 200 to the primitive transport layer module 320.

The MAC layer 340 and the physical layer 350 may follow the IEEE 802.15.4 protocol standard.

The Zigbee gateway 200 and the IP service server 300 according to an embodiment of the present invention can be connected through various wired/wireless networks such as Ethernet, Wibro, WLAN (Wireless Local Area Network), and the like, and may have a network interface for Ethernet, Wibro, WLAN, and the like, respectively, for data communication therethrough.

The primitive transport layer module 210 of the Zigbee gateway 200 and the primitive transport layer module 320 of the IP service server 300 according to an embodiment of the present invention have a primitive frame generation function, a primitive frame transfer function, and a primitive frame decomposition function.

FIG. 2 is a view schematically showing a format of a primitive frame packet according to an embodiment of the present invention.

As shown in FIG. 2, a primitive frame packet 400 according to an embodiment of the present invention includes a frame header 410 and a frame payload 420. The frame header 410 may indicate a type and a function of a frame (i.e., content of a frame payload 420), and have a fixed length. The frame payload 420 may include data and have a variable length.

The frame header 410 includes a protocol type field 411 indicating a used protocol, a service type field 412 indicating a service type provided by a primitive transport layer, a frame type field 413 indicating a type of a frame, a message type field 414 indicating a type of a primitive loaded in a frame, a sequence number field 415 indicating a sequence number of a frame, and a length field 416 indicating a length of a payload.

The protocol type field 411 indicates one of a TCP and UDP, and the service type field 412 indicates one of a command service, a data service, and an acknowledgement service. The frame type field indicates a command language. For example, the frame type field 413 may indicate one of a command language [ZPTL(ZigBee primitive transport layer) connect] instructing setting of connection of a primitive transport layer and a corresponding response command language (ZPTL connect response) and acknowledgement command language (ZPTL connect ack), a command language (ZPTL disconnect) instructing disconnection of a primitive transport layer and a corresponding response command language (ZPTL disconnect response), a message data (Message Data) indicating a data frame, and an acknowledgement data (Data Ack) indicating acknowledgement of data reception. The message type field 414 indicates a type of a primitive. For example, the message type field 414 may indicate one of various messages, e.g., 17 messages such as a network formation request message NLME (network layer management entity)-NETWORK-FORMATION-REQUEST], a network formation configuration message (NLME-NETWORK-FORMATION-CONFIRM), a network joining permission request message (NLME-PERMIT-JOINING-REQUEST), a network joining permission confirmation message (NLME-PERMIT-JOINING-CONFIRM), a network joining indication message (NLME-JOIN-INDICATION), a network direct joining request message (NLME-DIRECT-JOIN-REQUEST), a network direct joining confirmation message (NLME-DIRECT-JOIN-CONFIRM), a network leave request message (NLME-LEAVE-REQUEST), a network leave confirmation message (NLME-LEAVE-CONFIRM), a network leave indication message (NLME-LEAVE-INDICATION), a router start request message (NLME-START-ROUTER-REQUEST), a router start confirmation message (NLME-START-ROUTER-CONFIRM), a reset request message (NLME-RESET-REQUEST) of a network layer, a reset confirmation message (NLME-RESET-CONFIRM) of a network layer, a data request message [NLDE(network layer data entity)-DATA-REQUEST], a data confirmation message (NLDE-DATA-CONFIRM), and a data indication message (NLDE-DATA-INDICATION). The protocol type field 411, the service type field 412, the frame type field 413, and the message type field 414 may have a length of 1 octet, respectively.

The frame payload 420 includes a payload field 421. The payload field 421 includes a gang of parameters annexed to a certain primitive. In an embodiment of the present invention, the value of each parameter extends by an integer multiple of 1 octet so that the length of the payload field 421 can be indicated by an integer multiple of 1 octet. The parameters are loaded in order in which they are annexed to the primitive. Thus, 21 parameters are used and have an extended length as follows. Namely, parameter (ScanChannels) is set as a bitmap having a length of 32 bits, parameters (ScanChannels, BeaconOrder, SuperframeOrder, PAN ID, PermitDuration, ShortAddress, DstAddr, NsduLength, ScrAddr), and the like, are set to have a length of 16 bits, parameters (BatteryLifeExtension, DiscoverRoute, SecurityEnable), and the like, are boolean values which are set to have a length of 8 bits. Parameter (CapabilityInformation) is set as a bitmap having a length of 8 bits, parameters (ExtendedAddress, DeviceAddress) are set to have a length of 64 bits, respectively, and parameters (Status, NsduHandle, BroadcastRadius, LinkQuality), and the like, are set to have a length of 8 bits. Parameter (NSDU) has an octet length expressed by parameter (NsduLength).

Such a primitive frame packet 400 is determined by a function and a character. A primitive parameter constituting the primitive frame packet 400 is indicated as a data service in the service type field 412, and a message type correspding to the corresponding primitive is indicated in the message type field 414, a frame type is indicated in the frame type field 413, and a parameter annexed to the primitive is indicated in the frame payload 420. The length of the payload is related to the length field 416. Namely, the certain primitive frame packet 400 is generated as a data frame in which the service type field 412 is set to “data service”, the frame type field 413 is set to “message data”, the message type field 414 is set to a message type related to primitive data, the length field 416 is set to a length of data loaded in the payload, and the frame payload 420 is set to a parameter aggregate. The protocol type field 411 is set to any one selected from among TCP/UDP irrespective of a primitive, and the sequence number field 415 is set as a sequence number according to order in which a frame is generated irrespective of the function and character of the frame to be transmitted.

When the primitive frame packet 400 is for acknowledging reception of primitive and parameter data, it is indicated as an acknowledgement service for reception acknowledgement in the service type field 412, and although “data ack” is indicated in the frame type field 413, there is no meaning or payload with respect to the message type field 414. Here, although payload does not exist, its length corresponds to “length”. Thus, the frame for reception acknowledgement is generated as a frame in which the service type field 412 is set to “acknowledgement”, the frame type field 413 is set to “data ack”, the message type field 414 is set to “NULL” value which is meaningless, the length field 416 is set to a length, i.e., a value “0”, of data loaded in the payload, and the payload field 421 does not include any data. However, the protocol type field 411 and the sequence number field 415 are set to be the same as a data frame.

When the primitive frame packet 400 provides a command for a primitive transport layer, it is indicated as a command service in the service type field 412 and a type of the command and a character of a response thereof are indicated in the frame type field 413, but there is no meaning or payload with respect to the message type field 414. Here, although payload does not exist, its length corresponds to “length”. The types and responses of the command include command languages (ZPTL connect, ZPTL connect response, ZPTL connect ack, ZPTL disconnect, ZPTL disconnect response, etc.). A command frame is generated as a frame in which the service type field is set to a command service, the frame type field 413 is set to one of command languages (ZPTL connect, ZPTL connect response, ZPTL connect ack, ZPTL disconnect, ZPTL disconnect response) according to a command and a response, the message type field 414 is set to a “NULL” value which does not have a meaning, the length field 416 is set to a length, i.e., a value “0”, of data loaded in payload, and the payload field 421 does not include any data.

As for relationships between primitives and messages employed in an embodiment of the present invention, a NLME-NETWORK-FORMATION.request primitive corresponds to a network formation request message (NLME-NETWORK-FORMATION-REQUES), a NLME-NETWORK-FORMATION.confirm primitive corresponds to a network formation confirmation message (NLME-NETWORK-FORMATION-CONFIRM), a NLME-PERMIT-JOINING.request primitive corresponds to a joining permission request message (NLME-PERMIT-JOINING-REQUEST), a NLME-PERMIT-JOINING.confirm primitive corresponds to a joining permission confirmation request message (NLME-PERMIT-JOINING-CONFIRM), a NLME-JOIN.indication primitive corresponds to a joining network indication message (NLME-JOIN-INDICATION), a NLME-DIRECT-JOIN.request primitive corresponds to a direct network joining request message (NLME-DIRECT-JOIN-REQUEST), a NLME-DIRECT-JOIN.confirm primitive corresponds to a direct network joining confirmation message (NLME-DIRECT-JOIN-CONFIRM), a NLME-LEAVE.request primitive corresponds to a network leave request message (NLME-LEAVE-REQUEST), a NLME-LEAVE.confirm primitive corresponds to a network leave confirmation message (NLME-LEAVE-CONFIRM), a NLME-LEAVE.indication primitive corresponds to a network leave indication message (NLME-LEAVE-INDICATION), a NLME-START-ROUTER.request primitive corresponds to a router role start request message (NLME-START-ROUTER-REQUEST), a NLME-START-ROUTER.confirm primitive corresponds to a router role start confirmation message (NLME-START-ROUTER-CONFIRM), a NLME-RESET.request primitive corresponds to a network set value initialization message (NLME-RESET-REQUEST), a NLME-RESET.confirm primitive corresponds to a network set value initialization confirmation message (NLME-RESET-CONFIRM), a NLDE-DATA.rquest primitive corresponds to a data transfer request message (NLDE-DATA-REQUEST), a NLDE-DATA.confirm primitive corresponds to a data transfer confirmation message (NLDE-DATA-CONFIRM), and a NLDE-DATA.indication primitive corresponds to a data reception indication message (NLDE-DATA-INDICATION). Here, the relationships between the messages and the primitives may also be established as reverse relationships.

The primitives of the primitive frame packet 400 according to an embodiment of the present invention accompany different types of relevant parameters, and the relationships are as follows. Namely, the primitive (NLME-NETWORK-FORMATION.request) indicating a network formation request by a management entity of the Zigbee network layer module 120 accompanies parameters (ScanChannels, ScanDuration, BeaconOrder, SuperfameOrder, PANID, BatteryLifeExtension, etc.).

The primitive (NLME-NETWORK-FORMATION.confirm) indicating conformation of completion of a network formation to the management entity of the Zigbee network layer module 120 accompanies a parameter (Status), the primitive (NLME-PERMIT-JOINING.request) indicating a request of connection permission by the management entity of the Zigbee network layer module 120 accompanies a parameter (PermitDuration), and the primitive (NLME-PERMIT-JOINING.confirm) indicating confirmation with respect to a connection permission request by the management entity of the Zigbee network layer 120 accompanies a parameter (Status).

The primitive (NLME-JOIN.indication) indicating notification with respect to a network connection completion with respect to the management entity of the Zigbee network layer module 120 accompanies parameters (ShortAddress, Extended Address and CapabilityInformation, etc.), the primitive (NLME-DIRECT-JOIN.request) indicating a request of a direct network connection by the management entity of the Zigbee network layer module 120 accompanies parameters (DeviceAddress, CapabilityInformation, etc.), and the primitive (NLME-DIRECT-JOIN.confirm) indicating confirmation with respect to a completion of a direct network connection request to the management entity of the Zigbee network layer module 120 accompanies parameters (DeviceAddress and Status).

The primitive (NLME-LEAVE.request) indicating a request of network leaving by the management entity of the Zigbee network layer module 120 accompanies a parameter (DeviceAddress), and the primitive (NLME-LEAVE.confirm) indicating confirmation with respect to completion of network leaving with respect to the management entity of the Zigbee network layer module 120 accompanies the parameters (DeviceAddress and Status)

The primitive (NLME-LEAVE.indication) indicating notification with respect to network leaving to the management entity of the Zigbee network layer module 120 accompanies the parameter (DeviceAddress), and the primitive (NLME-START-ROUTER.request) indicating a request of initiation of a router role by the management entity of the Zigbee network layer module 120 accompanies parameters (BeaconOrder, SuperframeOrder and BatteryLifeExtension, etc.)

The primitive (NLME-START-ROUTER.confirm) indicating confirmation of initiation of a router role to the management entity of the Zigbee network layer module 120 accompanies the parameter (Status), the primitive (NLME-RESET.request) indicating a request of initialization of a network set value by the management entity of the Zigbee network layer module 120 does not have a relevant parameter, and the primitive (NLME-RESET.confirm) indicating confirmation with respect to completion of initialization of the network set value accompanies the parameter (Status).

The primitive (NLDE-DATA.request) indicating a request of data transfer by the management entity of the Zigbee network layer module 120 accompanies parameter (DstAddr, NsduLength, Nsdu, NsduHandle, BroadcastRadius, DiscoverRoute and SecurityEnable, etc.), the primitive (NLDE-DATA.confirm) indicating confirmation with respect to completion of data transfer requested from a data entity of the Zigbee network layer module 120 accompanies the parameters (NsduHandle and Status, etc.), and the primitive (NLDE-DATA.indication) indicating notification with respect to reception of data from the data entity of the Zigbee network layer module 120 accompanies the parameters (ScrAddr, NsduLength, Nsdu and LinkQuality, etc.). In this manner, when a certain primitive and parameter are received, or when they are received without an error, a data frame and an acknowledgement frame are generated, respectively.

Meanwhile, a command frame and a corresponding response frame are generated at timings different from those of the data frame and the acknowledgement frame. The command frame (ZPTL connect) is generated when the primitive (NLME-NETWORK-FORMATION.request) is received, the response frame (ZPTL connect response) is generated when the command frame (ZPTL connect) is received without an error, and the response frame (ZPTL connect ack) is generated when the response frame (ZPTL connect response) is received without an error. The response frame (ZPTL disconnect response) is generated when the command frame (ZPTL disconnect) is received without an error.

The primitive frame packet 400 is transmitted and received between the primitive transport layer module 210 of the Zigbee gateway 200 and the primitive transport layer module 320 of the IP service server 300 to allow a primitive frame for data, a command, acknowledgement, and the like, to be reliably notified to the Zigbee application layer module 110 and the Zigbee network layer module 120 of the Zigbee node 100.

Here, the generated primitive frame packet 400 such as a data frame, a command frame, an acknowledgement frame, or the like, is included in an IP packet and transmitted to a peer layer of the Zigbee node 100. To this end, the primitive transport layer module 210 and the primitive transport layer module 320 transfer a source port number and IP address and a destination port number and IP address, along with the frame, to the TCP(UDP)/IP layer. Here, the IP service server 300 and the Zigbee gateway 200 are previously informed of the source port number and IP address and the destination port number and IP address, respectively.

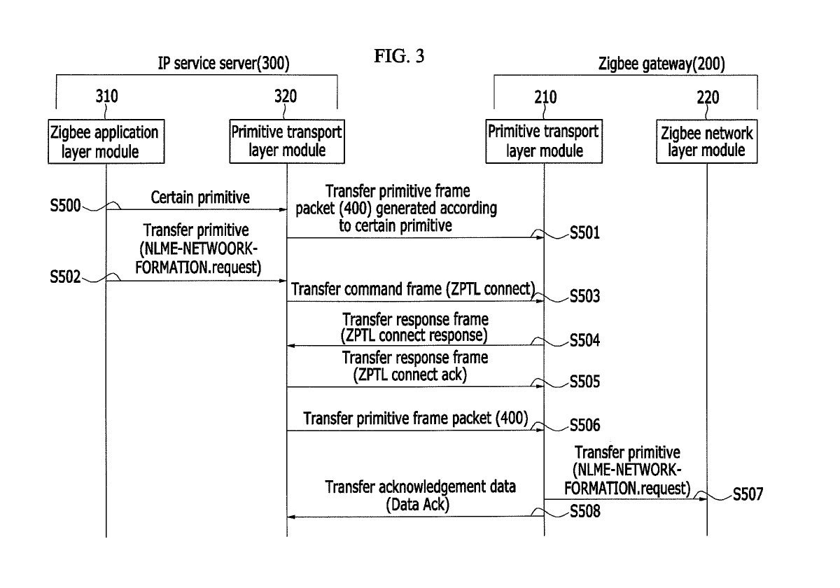

FIG. 3 is a view schematically showing transmission and reception of a primitive frame packet according to an embodiment of the present invention.

As shown In FIG. 3, the primitive transport layer module 210 of the Zigbee gateway 200 and the primitive transport layer module 320 of the IP service server 300 follow a communication procedure based on the received primitive frame packet 400.

The primitive transport layer module 320 of the IP service server 300 receives a certain primitive, excluding the primitive (NLME-NETWORK-FORMATION.request), from the Zigbee application layer module 310 (S500). The primitive transport layer module 320 transfers the primitive frame packet 400 generated according to the certain primitive to the primitive transport layer module 210 of the Zigbee gateway 200 (S501).

Here, when the primitive (NLME-NETWORK-FORMATION.request) is first received from the Zigbee application layer module 310 of the IP service server 300 (S502), the primitive transport layer module 320 transfers a command frame (ZPTL connect) to the primitive transport layer module 210 of the Zigbee gateway 200 before transferring the data primitive frame packet 400 generated according to the primitive (NLME-NETWORK-FORMATION.request) in order to establish a connection between the primitive transport layers (S503).

The primitive transport layer module 210 of the Zigbee gateway 200 transfers a response frame (ZPTL connect response) to the primitive transport layer module 320 of the IP service server 300 (S504).

The primitive transport layer module 320 of the IP service server 300 transfers a response frame (ZPTL connect ack) corresponding to the response frame (ZPTL connect response) to the primitive transport layer module 210 (S505). Subsequently, the primitive transport layer module 320 transfers message data generated according to a primitive (NLME-NETWORK-FORMATION.request) to the primitive transport layer module 210 (S506). Then, the primitive transport layer module 210 transfers a primitive (NLME-NETWORK-FORMATION.request) to the Zigbee network layer module 220 (S507).

The primitive transport layer module 210 of the Zigbee gateway 200 transfers acknowledgement data (Data Ack) corresponding to the message data to the primitive transport layer module 320 of the IP service server 300 (S508). Then, the primitive transport layer module 320 of the IP service server 300 does not perform any operation but is on standby (or waits) to receive a different frame or primitive, while maintaining an active state of the primitive transport layer connection.

In an embodiment of the present invention, parameters are used to reliably transfer data frames. Among the parameters is a parameter (T_Max_Wait_Ack) indicating a maximum reception standby time. This parameter is for a maximum reception standby allowed to receive a response frame after a data frame is transmitted, and the maximum reception standby time may be set by a timer.

Another parameter is a parameter (N_Max_Retrans) indicating a maximum retransmission number. This parameter is to repeat retransmission with respect to a data frame when an acknowledgement frame is not received within a parameter (T_Max_Wait_Ack) time. With this parameter applied, a transmitter, which has transmitted a certain data frame, may wait for an acknowledgement frame as a response during the parameter (T_Max_Wait_Ack) by using a timer. When an acknowledgement frame is not received within the standby time, the transmitter retransmits the data frame. Such a retransmission is repeated by the number of the parameter (N_Max_Retrans) until when an acknowledgement frame is received from a receiver.

When receiving of the primitive frame packet 400 is completed, the primitive transport layer module 210 of the Zigbee gateway 200 analyzes the primitive frame packet 400. Namely, the primitive transport layer module 210 analyzes the primitive frame packet 400 and reconfigures it into a primitive and a relevant parameter in such a format that can be identified and processed by the Zigbee application layer module 110 and the Zigbee network layer module 120.

In detail, the primitive transport layer module 210 decomposes the frame header 410 in order to identify the received primitive frame packet 400. Here, the frame header 410 is a series of a binary data string, so the respective fields constituting a frame header cannot be immediately checked. Thus, the primitive transport layer module 210 checks a field value with respect to each segment so that the data string can be divided into segments by the length of a configuration field of each frame header 410.

All of first segments, as the protocol type field 411, have the same value. Second to fourth segments, as the service type field 412, the frame type field 413, and the message type field 414, may have different values according to frames, and provide information allowing frames to be uniquely identified. Here, the service type field 412 is identified such that the received frame is for one among a command service, a data service, and a confirmation service according to a checked value. The frame type field 413 is identified such that the received frame is for one among commands according to a checked value. The message type field 414 is identified such that the received frame is for transmitting one of messages according to a checked value. A fifth segment is the sequence number field 415, which is checked by a sequence number of a reception frame and used as a sequence number of a response frame. Finally, a sixth segment is the length field 416 providing the length of payload of a reception frame.

If a value of the message type field 414 is “00000000” regardless of the value of the service type field 412 and the value of the frame type field 413, the length field 416, the sixth segment, has “NULL” and since the received frame does not have any payload, it does not require payload decomposition. Meanwhile, when the value of the message type field 414 is not “00000000”, the length field 416, the sixth segment, has a bit string, rather than “NULL”. Then, the reception frame is identified to transmit a relevant parameter as a primitive message, and it means that payload is required to be decomposed in order to reconfigure a parameter. Namely, when the value of the length field 416 is “NULL”, payload decomposition is not required, and when it is not “NULL”, payload decomposition is determined. In this manner, payload decomposition is determined by the value of the length field 416.

For example, it is noted that, when the value of the message type field 414 of the reception frame is a message (NLME-NETWORK-FORMATION-REQUEST), the payload field 421 of the reception frame includes a 32-bit parameter (ScanChannels), a 16-bit parameter (ScanDuration), a 16-bit parameter BeaconOrder), a 16-bit parameter (SuperfameOrder), a 16-bit parameter (PANID), a 8-bit parameter BatteryLifeExtension), and the like, as relevant parameters. When the header decomposition-completed residual data string is sequentially decomposed, six segments including one 32-bit segment, four 16-bit segments, one 8-bit segment, and the like, are obtained. Among them, when the value of the parameter(ScanChannels) is derived from the first segment, the value of the parameter(ScanDuration) is derived from the second segment, the value of the parameter(BeaconOrder) is derived from the third segment, and the value of the parameter(SuperfameOrder) is derived from the fourth segment, the value of the parameter(PANID) is derived from the fifth segment, and the value of the parameter(PANID) is drived from the sixth segment.

A frame having a different value of the message type field 414 may be decomposed in the same manner by applying the types and order of the parameters corresponding to the recognized primitives and the length of each parameter. Here, in case of a reception frame in which a value of the message type field 414 is the primitive (NLME-RESET-REQUEST), since a relevant parameter is not used, a payload decomposing process is not performed.

The process of reconfiguring the primitives and relevant parameters is a process of restoring them into a format that can be recognized and processed by the Zigbee application layer module 110 and the Zigbee network layer module 120 of the Zigbee node 100, and the process is performed based on the results obtained by decomposing the primitive frame packet 400 including the primitives and the relevant parameters.

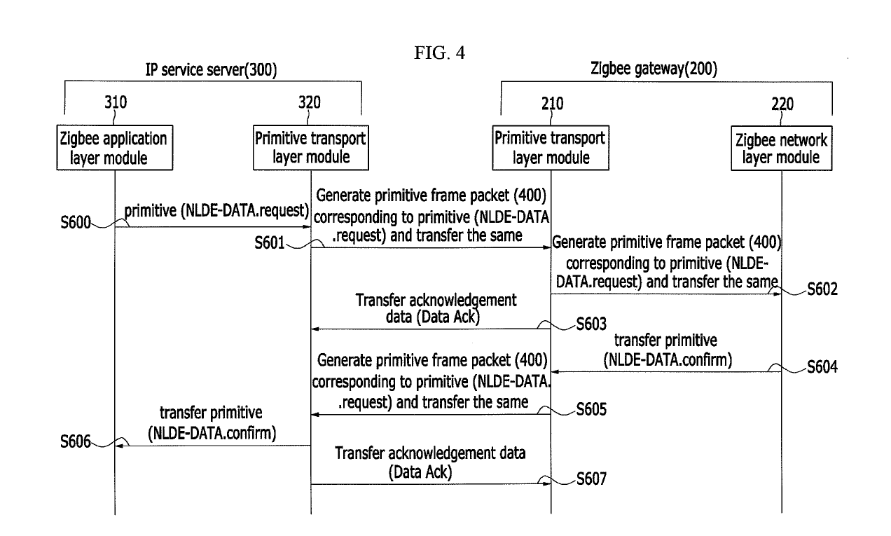

FIG. 4 is a view schematically showing a procedure of transferring a primitive message according to an embodiment of the present invention.

With reference to FIGS. 1 through 4, the primitive transport layer module 320 of the IP service server 300 receives primitives (NLDE-DATA.request, DstAddr, NsduLength, Nsdu, NsduHandle, BroadcastRadius, DiscoverRoute, SecurityEnable) from the Zigbee application layer module 310 (S600). The primitive transport layer module 320 generates the primitive frame packet 400 corresponding to the primitive (NLDE-DATA.request) and transfers the generated primitive frame packet 400 to the primitive transport layer module 210 of the Zigbee gateway 200 (S601). Namely, the primitive frame packet 400 is transferred from the primitive transport layer module 320 and transferred as an IP packet to the primitive transport layer module 210 through the TCP(UDP)/IP layer module 230 of the Zigbee gateway 200.

Here, the primitive (NLDE-DATA.request) accompanies a relevant parameter and corresponds to a message (NLDE-DATA-REQUEST), so the frame header 410 of the generated primitive frame packet 400 indicates “UDP” as a value of the protocol type field 411, indicates “data service” as a value of the service type field 412, indicates “message data” as a value of the frame type field 413, indicates “NLDE-DATA-REQUEST” as a value of the sequence number field 415, indicates “previous sequence number+1” as a value of the sequence number field 415, and indicates “68 octets” as a value of the length field 416. The frame payload 420 includes relevant parameters annexed to the primitive (NLDE-DATA.request) as a value of the payload field 421, and since 2-octet relevant parameter (DstAddr), 2-octet parameter(NsduLength), 2-octet parameter(Nsdu), 1-octet parameter(NsduHandle), 1-octet parameter(BroadcastRadius) 1-octet parameter(DiscoverRoute), and 1-octet parameter(SecurityEnable) are contiguous, the primitive frame packet 400 is comprised of the 7-octet frame header 410 and the 68-octet frame payload 420, constituting a data string having a total of 75 octets. Here, it is assumed that the parameter (NSDU) has a 60-octet length.

Next, the primitive transport layer module 210 of the Zigbee gateway 200 analyzes the received primitive frame packet 400. The first 7 octets of the data string of the primitive frame packet 400 are the frame header 410 including six fields 411 to 416, so the primitive transport layer module 210 divides the first part of the data string of the primitive frame packet 400 into five one-octet segments and one 2-octet segment. Namely, the primitive transport layer module 210 detects “UDP” as a value of the protocol type field 411, “data service” as a value of the service type field 412, “message data” as a value of the frame type field 413, “NLDE-DATA-REQUEST” as a value of the message type field 414, “previous sequence number+1” as a value of the sequence number field 415, and an attribute value of “68 octets” as a value of the length field 416 which are sequentially identified from the respective divided segments.

And, since the other remaining 68 octets of the data string of the primitive frame packet 400 are the frame payload 420 including the relevant parameters, the primitive transport layer module 210 sequentially divides the remaining portion of the data string of the primitive frame packet 400 into two 2-octet segments, a 60-octet segment, and four 1-octet segments. Namely, the primitive transport layer module 210 sequentially detects respective attribute values of the parameters (DstAddr, NsduLength, Nsdu, NsduHandle, BroadcastRadius, DiscoverRoute, SecurityEnable) [symbol] .

The reception message (NLDE-DATA-REQUEST) identified by the message type field 414 through the reconfiguration process of the primitive frame packet 400 is indicated as a primitive (NLDE-DATA.request), so the primitive transport layer module 210 reconfigures the message (NLDE-DATA-REQUEST) such that it has the same format as that transferred from the Zigbee application layer module 310 of the IP service server 300 and transfers the same to the Zigbee network layer module 220 (S602). At the same time, the primitive transport layer module 210 transfers acknowledgement data (Data Ack) as an IP packet to the TCP(UDP)/IP layer module 330 of the IP service server 300 through the TCP(UDP)/IP layer module 230, and the TCP(UDP)/IP layer module 330 transfers the acknowledgement data (Data Ack) to the primitive transport layer module 320 (S603).

In the same manner, when the primitive frame packet 400 correspoonding to the primitive (NLDE-DATA.confirm) is generated and transferred as the IP packet from the Zigbee gateway 200, the IP service server 300 analyzes and reconfigures the primitive frame packet 400 in the same manner as the primitive transport layer module 210 of the Zigbee gateway 200 does (S604 to S606).

In this manner, in the system for interworking between the IP network and the Zigbee network according to an embodiment of the present invention, since the Zigbee application layer module 310 and the Zigbee network layer module 220 are located in the IP service server 300 and the Zigbee gateway 200 having an IP network interface, respectively, with the IP network interposed therebetween, a unique communication procedure can be maintained, and since the primitive frame packet 400 including primitives and relevant parameters exchanged between the IP service server 300 and the Zigbee gateway 200 is transferred by a TCP/IP packet to both systems according to a reliable communication procedure, the IP service server 300 located at one side of the IP network can directly interwork to communicate with the Zigbee node 100 by a Zigbee application layer message in the Zigbee network located at the other side of the IP network. Also, there is no need to construct application software, an application profile, an interworking gateway, and the like, for cooperative operation between the IP network and the Zigbee network, the present invention can be applicable to various Zigbee application fields, and since a particular Zigbee node 100 can be directly accessed and data can be easily obtained, complexity of the Zigbee gateway 200 can be reduced.

The embodiments of the present invention as described above are not implemented only through a device and a method; the embodiments may be implemented through a program implementing the function corresponding to the configuration of the embodiments of the present invention or a recording medium storing the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to embodiments of the present invention, since the mutually separated Zigbee application layer module and the Zigbee network layer module are located in the service server and the Zigbee gateway having the IP network interface, respectively, with the IP network interposed therebetween, the original communication procedure can be used as it is. Also, since a primitive and a relevant parameter exchanged between layers through the primitive transport layer module are generated as a single primitive frame packet and transferred according to a TCP/IP packet, the service server can transfer a Zigbee application layer message as it is to the Zigbee node at the opposite side of the IP network, thus providing effective interworking between the IP network and the Zigbee network.

In addition, according to embodiments of the present invention, since the mutually separated Zigbee application layer module and the Zigbee network layer module are located in the service server and the Zigbee gateway having the IP network interface, respectively, with the IP network interposed therebetween, a particular node can be directly accessed and data can be easily obtained, and the application server perfectly manages a management function of the Zigbee network to thus support various Zigbee applications based on the IP network, such as real-time monitoring, remote controlling, and the like.

What is claimed is:

1. A Zigbee gateway connected to a Zigbee node by a Zigbee network and connected to an IP service server through an IP network, the Zigbee gateway comprising:
a primitive transport layer module extracting first data from a first primitive frame packet transferred through the IP network from the IP service server;
a Zigbee network layer module receiving the first data from the primitive transport layer module and transferring the first data to the Zigbee node.

2. The Zigbee gateway of claim 1, wherein the first data comprises at least one of a primitive and a parameter.

3. The Zigbee gateway of claim 1, further comprising:
a TCP/IP layer or a UDP/IP layer receiving the first primitive frame packet transferred through the IP network and transferring the received first primitive frame packet to the primitive transport layer module.

4. The Zigbee gateway of claim 1, wherein the primitive transport layer module receives second data transferred from the Zigbee network layer module, generates a second primitive frame packet including the second data, and transfers the second primitive frame packet to the IP service server.

5. The Zigbee gateway of claim 4, wherein the first primitive frame packet comprises frame payload including a frame header and the first data, and the second primitive frame packet comprises frame payload including a frame header and the second data.

6. The Zigbee gateway of claim 5, wherein the frame header comprises a message type field indicating a type of the data included in the frame payload and a length field indicating the length of the frame payload.

7. An IP service server interworking with a Zigbee gateway through an IP network, the IP service server comprising:
a primitive transport layer module extracting first data from a first primitive frame packet transferred through the IP network from the Zigbee gateway;
a Zigbee application layer module receiving the first data from the primitive transport layer module.

8. The IP service server of claim 7, wherein the first data comprises at least one of a primitive and a parameter.

9. The IP service server of claim 7, further comprising:
a TCP/IP layer or a UDP/IP layer receiving the first primitive frame packet transferred through the Zigbee gateway and transferring the received first primitive frame packet to the primitive transport layer module.

10. The IP service server of claim 7, wherein the primitive transport layer module receives second data transferred from the Zigbee application layer module, generates a second primitive frame packet including the second data, and transfers the second primitive frame packet to the Zigbee gateway.

11. The IP service server of claim 10, wherein the first primitive frame packet comprises frame payload including a frame header and the first data, and the second primitive frame packet comprises frame payload including a frame header and the second data.

12. The IP service server of claim 11, wherein the frame header comprises a message type field indicating a type of the data included in the frame payload and a length field indicating the length of the frame payload.
